(19) United States
(12) Patent Application Publication
(10) Pub. No.: US 2019/0339384 A1
(43) Pub. Date: Nov. 7, 2019

(54) SYSTEM AND METHOD OF RADAR-BASED OBSTACLE AVOIDANCE FOR UNMANNED AERIAL VEHICLES

(71) Applicant: SZ DJI TECHNOLOGY CO., LTD., Shenzhen (CN)

(72) Inventors: Xueming PENG, Shenzhen (CN); Han HUANG, Shenzhen (CN); Qiang GU, Shenzhen (CN); Xiaying ZOU, Shenzhen (CN)

(21) Appl. No.: 16/518,655

(22) Filed: Jul. 22, 2019

Related U.S. Application Data
(63) Continuation of application No. PCT/CN2017/072451, filed on Jan. 24, 2017.

(51) Int. Cl. G01S 13/94; G01S 13/93

(52) U.S. Cl. CPC G01S 13/94; B64C 2201/141; G01S 13/9303

(57) ABSTRACT

A method for radar-based object avoidance for a movable platform includes performing a plurality of “ping-pong” measurements to receive electromagnetic signals corresponding to an object and background clutters by a radar of the movable platform, and distinguishing the object from the background clutters. Each of the “ping-pong” measurements includes a first measurement and a second measurement. A first direction of the first measurement is different from a second direction of the second measurement.

### CROSS-REFERENCE TO RELATED APPLICATION

This application is a continuation of International Application No. PCT/CN2017/072451, filed on Jan. 24, 2017, the entire content of which is incorporated herein by reference.

### TECHNICAL FIELD

The present disclosure generally relates to the field of obstacle avoidance technology and more particularly, but not exclusively, to a system and a method for radar-based obstacle avoidance for unmanned aerial vehicles (UAVs).

### BACKGROUND

Unmanned aerial vehicles (UAVs) have great potential to be widely used in both civil and military applications. Because of their low cost, safety benefit and mobility, UAVs may potentially replace manned aerial vehicles in many tasks as well as perform well in curriculums that tradition manned aerial vehicles do not. However, as there is no on-board human control, UAVs' usage encounters several challenges that need to be overcome, one of which is obstacle avoidance. UAVs need to avoid collision with both static and moving obstacles.

Existing obstacle avoidance technologies include ultrasonic obstacle avoidance, visual obstacle avoidance, and time-of-flight (TOF) obstacle avoidance, etc. One main drawback of ultrasonic obstacle avoidance is the substantially short detection distance, and some objects capable of absorbing ultrasound (such as carpet) may not be accurately detected. TOF obstacle avoidance has poor anti-interference capabilities, and its detection distance is often limited to about ten meters.

Visual obstacle avoidance, which requires the obstacles to have certain texture information for feature matching, is greatly affected by weather, and its detection distance is often limited to about twenty meters. Obstacles without plenty of texture information, e.g., linear obstacle or planar obstacle having undistinguished surface texture, such as glass, wire mesh, may be difficult to be detected. Moreover, when the relative speed of an obstacle target and the UAV is relatively large, the obstacle detection performance of visual obstacle avoidance may be significantly degraded.

The disclosed system and method for radar-based obstacle avoidance for UAVs thereof are directed to solve one or more problems set forth above and other problems.

### BRIEF SUMMARY OF THE DISCLOSURE

One aspect of the present disclosure provides a method for radar-based object avoidance for a movable platform. The method includes performing a plurality of “ping-pong” measurements to receive electromagnetic signals corresponding to an object and background clutters by a radar of the movable platform, and distinguishing the object from the background clutters. Each of the “ping-pong” measurements includes a first measurement and a second measurement. A first direction of the first measurement is different from a second direction of the second measurement.

Another aspect of the present disclosure provides a system for radar-based object avoidance for a movable platform. The system includes a radar and a radar data processing unit. The radar is configured to perform a plurality of “ping-pong” measurements of to receive electromagnetic signals corresponding to an object and background clutters. The radar data processing unit is configured to distinguish the object from the background clutters. Each of the “ping-pong” measurements includes a first measurement and a second measurement. A first direction of the first measurement is different from a second direction of the second measurement.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 schematically shows an exemplary movable platform consistent with the disclosure.

FIG. 2 shows a block diagram of an exemplary control system for the movable platform consistent with the disclosure.

FIGS. 3A and 3B schematically illustrate an exemplary first EM beam and an exemplary second EM beam, respectively, emitted by a radar on the movable platform, consistent with the disclosure.

FIG. 4 schematically shows an exemplary vᵣ-r plot for illustrating screening of received EM signals consistent with the disclosure.

FIGS. 5A and 5B illustrate exemplary setups for calculating the a object direction angle consistent with the disclosure.

FIGS. 6A and 6B illustrate exemplary matching of obstacles in a previous “ping-pong” measurement frame and a current “ping-pong” measurement frame consistent with the disclosure.

FIG. 7 schematically illustrates an unmanned aerial vehicle consistent with the disclosure.

FIG. 8 illustrates a flow chart of an exemplary method for radar-based object avoidance for a movable platform consistent with the disclosure.

FIG. 9 illustrates a flow chart of an exemplary method for matching and correlating object information of two “ping-pong” measurement frames and establishing a corresponding relationship of the object of the two “ping-pong” measurement frames, consistent with the disclosure.

FIG. 10 illustrates a flow chart of an exemplary method for predicting future object information of the matched object consistent with the disclosure.

FIG. 11 illustrates a flow chart of an exemplary method for calculating a movement plan to avoid the matched object and operating the movable platform according to the movement plan consistent with the disclosure.

### DETAILED DESCRIPTION

Reference will now be made in detail to exemplary embodiments of the disclosure and the accompanying drawings. Hereinafter, embodiments consistent with the disclosure will be described with reference to the drawings. Wherever possible, the same reference numbers will be used throughout the drawings to refer to the same or like parts. The described embodiments are some but not all of the embodiments of the present disclosure. Based on the disclosed embodiments, persons of ordinary skill in the art may derive other embodiments consistent with the present disclosure, all of which are within the scope of the present disclosure. Further, in the present disclosure, the disclosed embodiments and the features of the disclosed embodiments may be combined under conditions without conflicts.

The present disclosure provides a system and a method for radar-based object avoidance for a movable platform. The radar-based object avoidance system and method can be based on a radio frequency (RF) radar, such as a microwave radar, which is usually not affected by sunlight, smoke, fog, dust, or other factors that typically affect optical waves, and typically has improved directionality and range characteristics when compared with acoustic systems. The RF radar can detect an object or multiple objects, such as an obstacle or multiple obstacles, within a distance from about one meter to several hundred meters, including linear and planar objects, such as branches, cables, and barbed wires, etc., and can acquire various information of both static and moving objects, e.g., aircrafts in a multiple-aircraft formation flight.

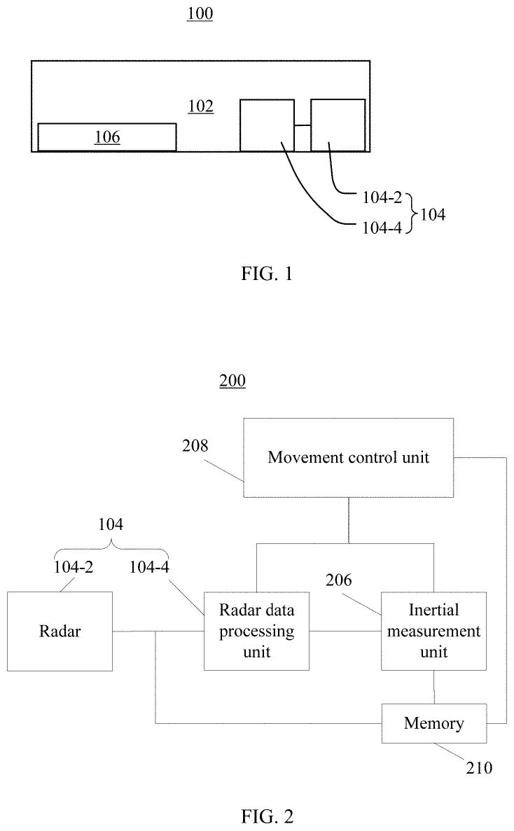

FIG. 1 schematically shows an exemplary movable platform 100 consistent with the disclosure. The movable platform 100 can be any type of movable platform capable of operating automatically or semi-automatically, such as, for example, an unmanned aerial vehicle (UAV), a bicycle, an automobile, a truck, a ship, a boat, a train, a helicopter, an aircraft, or a hybrid of two or more types of movable platforms. As shown in FIG. 1, the movable platform 100 includes a main body 102, a radar-based object avoidance system 104 installed on or in the main body 102, and a propulsion system 106 connected to the main body 102.

The main body 102 constitutes a housing for accommodating various components of the movable platform 100, such as, for example, a control system (which may include the radar-based object avoidance system 104, as described below), one or more inertial measuring units (IMUs), one or more processors, one or more power sources, and/or other sensors.

The radar-based object avoidance system 104 includes a radar 104-2 and a radar data processing unit 104-4. The radar 104-2 can be directly mounted on the main body 102 of the movable platform 100. For example, the radar 104-2 can be mounted on the front, the back, the left, or the right of the main body 102. Further, the radar 104-2 can be mounted on any appropriate portion of the main body 102 through any appropriate mechanism, as long as such a mounting allows the radar 104-2 to efficiently transmit electromagnetic (EM) waves and receive reflected EM waves from object(s) in the path of the transmitted EM waves. In some embodiments, the radar 104-2 may be especially adapted for use in the movable platform 100. For example, the radar 104-2 may be power efficient, lightweight, and compact to avoid over-encumbering the movable platform 100.

Consistent with the disclosure, the radar 104-2 can include one or more transmitter producing the EM waves, e.g., in the radio frequency domain, one or more emitting antennas or antenna arrays to emit the EM waves (also referred to as emitted signal), and one or more receiving antennas or antenna arrays (different from or the same as the emitting antennas or antenna arrays) to capture any returns from the object(s). According to the returns, the radar 104-2 can generate radar data and send the radar data to the radar data processing unit 104-4, which can, for example, process the radar data to determine properties or information of the object(s), also referred to as “object information,” as discussed in more detail below. For example, one or more data processors in the radar data processing unit 104-4 can be configured to execute a method consistent with the disclosure, such as one of the exemplary methods described below, to process the radar data.

FIG. 2 shows a block diagram of an exemplary control system 200 for the movable platform 100, consistent with the disclosure. As shown in FIG. 2, the control system 200 includes the radar-based object avoidance system 104, an inertial measurement unit (IMU) 206, and a movement control unit 208 coupled to each other.

The IMU 206 can include, for example, one or more accelerometers, one or more gyroscopes, and/or one or more magnetometers. The IMU 206 can detect acceleration information of the movable platform 100, such as, for example, a linear acceleration and/or changes in rotational attributes (such as pitch, roll, and yaw) of the movable platform 100. In some embodiments, the acceleration information may additionally or alternatively include a centripetal acceleration, which can be used to determine an angular velocity of the movable platform 100. The IMU 206 sends the acceleration information to the radar data processing unit 104-4 and/or the movement control unit 208. The movement control unit 208 sends movement control information to the radar data processing unit 104-4. The movement control information can include, for example, coordinates (latitude, longitude, and elevation) of the movable platform 100 in the geographic coordinate system, a velocity of the movable platform 100, and/or an attitude of the movable platform 100 (if the movable platform 100 is an aircraft). The radar data processing unit 104-4 can process the radar data, the acceleration information, and/or the movement control information to generate the object information and send the object information to the movement control unit 208 for controlling the movable platform 100 to avoid the object(s).

In some embodiments, as shown in FIG. 2, the control system 200 further includes a memory 210, which is configured to store, for example, various data such as the radar data, the acceleration information, and/or the movement control information, predetermined algorithms, and instructions for implementing various processes, such as processes consistent with the disclosure. The predetermined algorithms and instructions can be executed by various processors (not shown) in the control system 200, such as the one or more radar data processors in the radar data processing unit 104-4 and/or one or more movement control processor in the movement control unit 208. Consistent with the disclosure, the memory 210 can include a non-transitory computer-readable storage medium, which includes one or more of, for example, a read-only memory (ROM), a random-access memory (RAM), a flash memory, or a mass storage, such as a CD-ROM or a hard disk.

In some embodiments, the radar 104-2 includes a first emitting antenna or antenna array for emitting a first EM beam expanding in a range of angles in a first direction and a second emitting antenna or antenna array for emitting a second EM beam expanding in a range of angles in a second direction different from the first direction. The first and second directions, also referred to as first and second measurement directions or first and second scanning directions, are different from each other, and can, for example, be approximately perpendicular to each other. It is noted, however, that the terms “first” and “second” do not imply any order, such as the order in which the first and second EM beams are emitted. For example, the second beam can be emitted after the first beam is emitted, the first beam can be emitted after the second beam is emitted, or the first and second beams can be emitted simultaneously.

In some embodiments, the first direction includes a horizontal direction and the second direction includes a vertical direction. The horizontal direction and the vertical direction can be defined, for example, with respect to the ground. That is, the horizontal direction is parallel to the ground and the vertical direction is perpendicular to the ground. Alternatively, the horizontal direction and the vertical direction can be defined with respect to a plane on the movable platform, such as an upper surface of the movable platform. That is, the horizontal direction is parallel to the upper surface of the movable platform and the vertical direction is perpendicular to the upper surface of the movable platform.

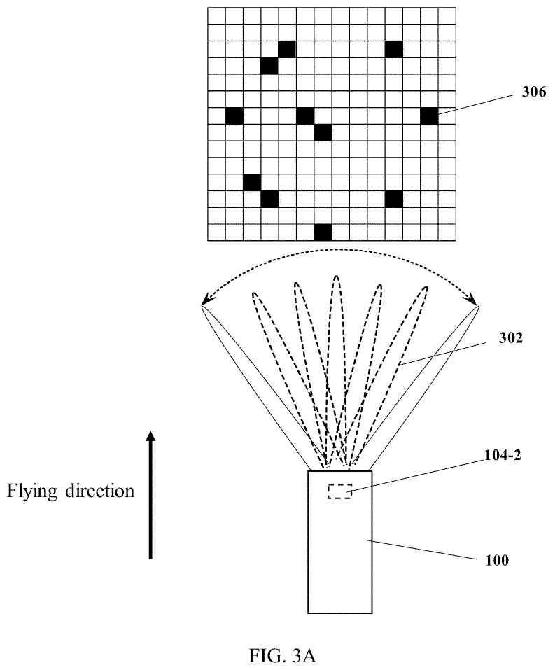

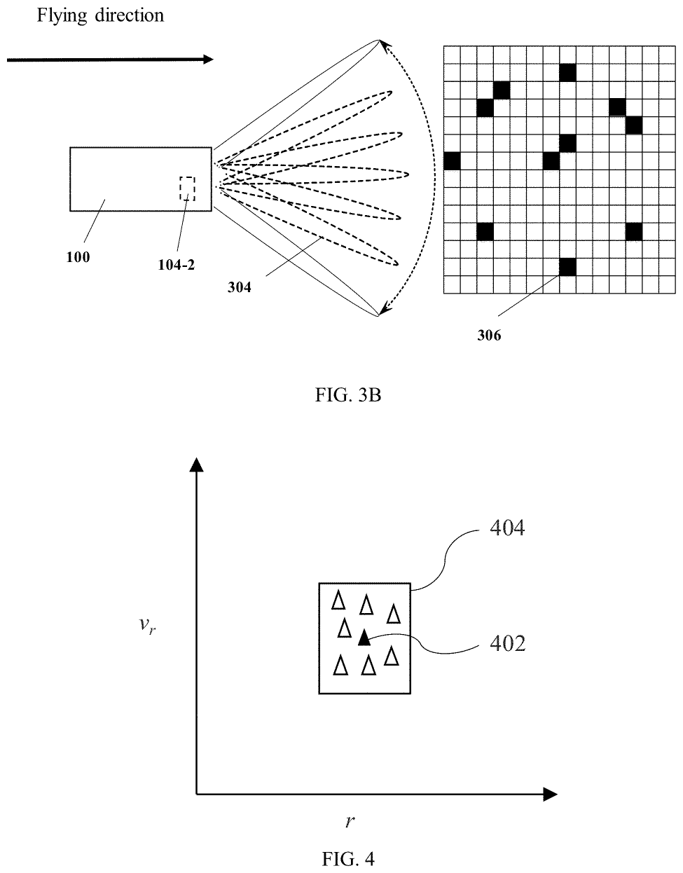

FIGS. 3A and 3B schematically illustrate an exemplary first EM beam 302 and an exemplary second EM beam 304, respectively, emitted by the radar 104-2. The range of angels of the first EM beam 302, which is also referred to as an antenna beam width of the radar 104-2 in the first direction, determines a measurement range of the radar-based object avoidance system 104 in the first direction. Correspondingly, the range of angels of the second EM beam 304, which is also referred to as an antenna beam width of the radar 104-2 in the second direction, determines a measurement range of the radar based object avoidance system 104 in the second direction. Consistent with the disclosure, the antenna beam width of the radar 104-2 in the first direction, also referred to as a “first antenna beam width,” and the antenna beam width of the radar 104-2 in the second direction, also referred to as a “second antenna beam width,” can be the same as or different from each other.

For example, as shown in FIG. 3A, the first EM beam 302 can expand from a first positive maximum measurement angle, e.g., θmax1, to a first negative maximum measurement angle, e.g., −θmax1, measured in the first direction with respect to a moving direction of the movable platform 100. Similarly, as shown in FIG. 3B, the second EM beam 304 can expand from a second positive maximum measurement angle, e.g., θmax2, to a second negative maximum measurement angle, e.g., −θmax2, measured in the second direction with respect to the moving direction of the movable platform 100. The first and second positive maximum measurement angles can be the same as or different from each other. Similarly, the first and second negative maximum measurement angles can be the same as or different from each other. In the examples shown in FIGS. 3A and 3B, each of the first and second EM beams 302 and 304 is approximately symmetric with respect to the moving direction of the movable platform 100, i.e., the absolute values of the positive and negative maximum measurement angles approximately equal each other in both the first and second directions. For example, the first and second EM beams 302 and 304 can expand from about −40° to about 40° in the first and second directions, respectively. That is, the radar 104-2 can have a first antenna beam width of about 80° and a second antenna beam width of about 80°. In some embodiments, one or both of the first and second EM beams 302 and 304 can be asymmetric with respect to the moving direction of the movable platform 100.

In some embodiments, the radar 104-2 includes a first receiving antenna array for detecting part of the first EM beam 302 that is reflected, e.g., by an object 306, also referred to as “first reflected EM signals.” The radar 104-2 further includes a second receiving antenna array for detecting part of the second EM beam 304 that is reflected, e.g., by the object 306, also referred to as “second reflected EM signals.” In some embodiments, the first and second emitting antenna arrays can also serve as the first and second receiving antenna arrays, respectively. Hereinafter, the first receiving antenna array and the second receiving antenna array are referred to for the purposes of description. It is noted, however, that the terms “first receiving antenna array” and “second receiving antenna array” may also refer to the first emitting antenna array and the second emitting antenna array, respectively, when they also function as receiving antenna arrays.

Using the radar 104-2 described above, the movable platform 100 can detect, or measure, an object, e.g., an obstacle, such as the object 306 shown in FIGS. 3A and 3B, near the movable platform 100 in a “ping-pong” mode, which includes one or more “ping-pong” measurements, for example, performed in sequence, as described in more detail below. Hereinafter, some exemplary embodiments are described with respect to one object. It is noted, however, that such description also applies to the scenario in which there are multiple objects. Specifically, the radar-based object avoidance system 104 of the movable platform 100 is configured to perform the one or more “ping-pong” measurements, each of which includes a first measurement in the first direction and a second measurement in the second direction. Thus, the “ping-pong” mode includes one or more first measurements in the first direction and one or more second measurements in the second direction that are performed alternately. By performing a “ping-pong” measurement, the radar 104-2 can receive the first and second reflected EM signals, generate the radar data including first radar data and second radar data according to the first and second reflected EM signals, respectively, and send the radar data to the radar data processing unit 104-4. The radar data processing unit 104-4 can process the radar data to obtain the object information of the object 306, including, for example, a distance and a relative velocity between the movable platform 100 and the object 306, and direction angles of the object 306 with respect to the movable platform. In some embodiments, the object information can further include a relative angular velocity of the movable platform 100 with respect to the object 306. The distance between the movable platform 100 and the object 306 is also referred to as an “object range.” The relative velocity between the movable platform 100 and the object 306 is also referred to as an “object relative velocity.” The direction angles, also referred to as “object direction angles,” can include a first object direction angle measured in the first direction and a second object direction angle measured in the second direction. In the embodiments that the first and second directions are the horizontal direction and the vertical direction, respectively, the first object direction angle can be a horizontal object direction angle, also referred to as an “azimuth angle,” and the second object direction angle can be a vertical object direction angle, also referred to as an “elevation angle.” The period of time for the radar based object avoidance system 104 to perform the first and second measurements is usually relative short, such as in several milliseconds. Within this period of time, the object information can be considered as unchanged. According to the disclosure, after the movable platform processes the received RF signals, the movable platform can repeat the above-described process.

The first measurement will now be described in more detail. The second measurement is essentially similar to the first measurement, but merely in a different direction, and thus detailed description thereof is omitted.

According to the disclosure, the radar 104-2 emits the first EM beam 302, detects the first reflected EM signals, generates the first radar data, and sends the first radar data to the radar data processing unit 104-4 for processing. In some embodiments, the first reflected EM signals may include EM signals reflected by the object 306, which constitutes the useful signal data, and EM signals unrelated to the object 306, i.e., background clutters. The background clutters can initiate from various sources. For example, part of the background clutters may be caused by the radar based object avoidance system 104 itself, e.g., the intrinsic noise of the radar based object avoidance system 104. Further, part of the background clutters may result from the environment of the object 306. The first reflected EM signals need to be processed to distinguish the object 306 from the background clutters.

Various factors and approaches can be used to distinguish the object 306 from the background clutters. In some embodiments, the radar data processing unit 104-4 processes the first radar data to calculate a set of parameters associated with each of the first reflected EM signals. Each of the first reflected EM signals represents one potential candidate, which may be the object 306 or the background clutters. The parameters can include, for example, a candidate range, a candidate relative velocity, and a candidate signal strength. Consistent with the disclosure, one or more of the candidate range, the candidate relative velocity, or the candidate signal strength can be used to distinguish the object 306 from the background clutters, and the object direction angles can then be determined for the distinguished object 306. In some embodiments, direction angles can be determined for all of the potential candidates and then used to distinguish the object 306 from the background clutters. However, this approach may require a higher amount of computation capability and a longer computation time.

In some embodiments, the candidate range of a potential candidate can be calculated using

r=c·t/2 (1)

where r denotes the candidate range, c denotes the speed of light in vacuum (approximately 3.0×10⁸ m/s), t denotes the period of time between the time when the first EM beam is transmitted by the radar 104-2 and the time when the first reflected EM signal is received by the radar 104-2. Further, the candidate relative velocity of the potential candidate can be calculated using, e.g., Doppler information from the relative movement between the potential candidate and the movable platform 100, such as the Doppler frequency shift. For example, a radial component of the candidate relative velocity, which is in the direction parallel to the line connecting the movable platform 100 and the potential candidate can be calculated using

vᵣ=λ·f_{D}/2 (2)

where vᵣ denotes the radial component of the candidate relative velocity, λ denotes a wavelength of the first EM beam, and f_{D} denotes the Doppler frequency shift. The Doppler frequency shift f_{D} can be positive or negative, depending on whether the potential candidate, such as the object 306, is moving toward or away from the movable platform 100. Correspondingly, the radial component of the candidate relative velocity can be positive or negative. Other components of the candidate relative velocity, such as an azimuth component v_{φ} (in the horizontal direction) and an elevation component v_{θ} (in the vertical direction) can be calculated according to angle estimation using one or more of, e.g., the radial component of the candidate relative velocity, the candidate range, and the candidate direction angles.

The calculated candidate ranges and candidate relative velocities (such as the radial components) can be used to screen the potential candidates to distinguish the object 306 from the clutters. An exemplary method is discussed below with reference to FIG. 4. FIG. 4 schematically shows an exemplary vᵣ-r plot. Each data point in the vᵣ-r plot is associated with one potential candidate. As shown in FIG. 4, for a data point 402, neighboring data points, such as those within a box 404, are counted to calculate a number of data points within the box 404, which is then used to determine how likely the data point 402 is associated with the object 306.

Sometimes, two or more potential candidates, such as two or more objects, are located at a similar distance away from the movable platform 100, and thus may not be able to be distinguished from each other based on the candidate ranges. In the disclosure, a range resolution of the radar 104-2 is defined as the minimum separation (in range) of two candidates that can be resolved as separate candidates, which can be calculated using c/2B, where B denotes a bandwidth of the first EM beam. Thus, to improve the range resolution, a broad-band radar can be used as the radar 104-2. For example, when the bandwidth of the first EM beam is about 1 GHz, the range resolution of the radar 104-2 is about 0.15 m. That is, if the range difference between two potential candidates, even if they are in different directions, is smaller than about 0.15 m, the radar based object avoidance system 104 may not be able to distinguish the two potential candidates based on their ranges.

Usually, the signal strength associated with the object 306 is higher than the signal strength associated with the background clutters. Therefore, alternatively or in addition to using the candidate ranges and the candidate relative velocities, the candidate signal strengths can be used to screen the potential candidates to distinguish the object 306 from the background clutters. In some embodiments, a constant-false-alarm-rate (CFAR) detection algorithm may be adopted. The role of the CFAR algorithm is to determine a strength threshold above which a first reflected EM signal can be considered to probably originate from an object. The threshold can be set based on experience or statistic results. A lower threshold may ensure that more objects can be detected but the number of false alarms, i.e., a reflected EM signal being incorrectly identified as originated from an object, may increase. On the other hand, a higher threshold may reduce the number of false alarms but some object(s) may be missed. Consistent with the disclosure, the threshold can be set to achieve a required probability of false alarm (or equivalently, false alarm rate or time between false alarms).

In some embodiments, the background clutters against which the objects are to be detected is constant with time and space, and thus a fixed threshold may be chosen that provides a specified probability of false alarm, governed by a probability density function of the noise, which is usually assumed to be Gaussian. The probability of detection is then a function of the signal-to-noise ratio of the target return. In some embodiments, the noise level changes both spatially and temporally, such as when the movable platform 100 is moving. In these embodiments, a changing threshold may be used, where the threshold can be raised and lowered to maintain a constant probability of false alarm.

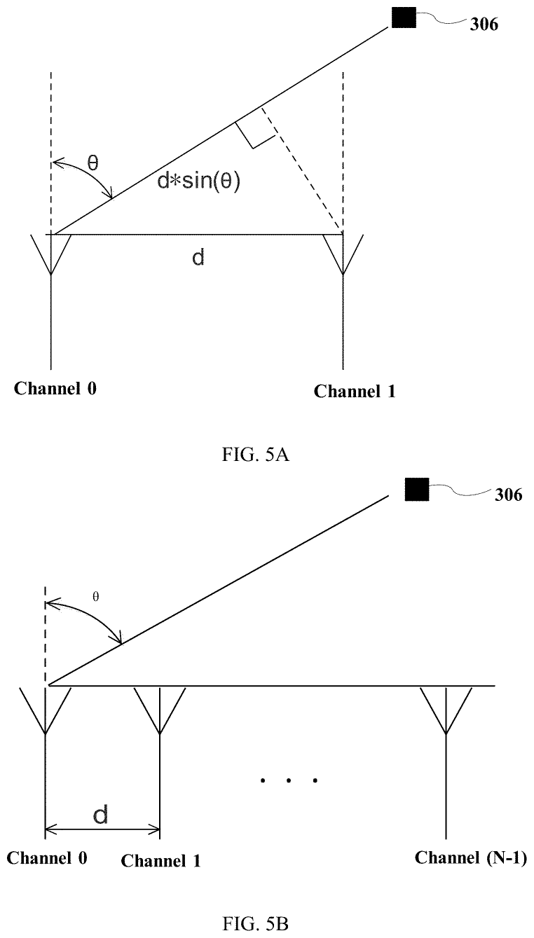

After the object 306 is distinguished from the background clutters, the first object direction angle, e.g., the horizontal angle for the distinguished object 306 can be calculated based on the first reflected EM signal associated with the object 306. FIGS. 5A and 5B illustrate exemplary setups for determining the first object direction angle of the object 306 consistent with the disclosure. In the example shown in FIG. 5, the first receiving antenna array of the radar 104-2 includes two channels, referred to as Channel 0 (or the 0th channel) and Channel 1 (or the 1st channel), respectively. Each of the two channels includes an antenna or a group of antennas arranged close to each other. In some embodiments, the first object direction angle of the object 306 can be calculated using:

$$Phase 0 - Phase 1 = exp ( j \cdot 2 π \frac{d sin θ}{λ} ) \qquad ( 3 )$$

where θ denotes the first object direction angle of the object, Phase0 denotes a phase of the first reflected EM signal corresponding to the object when received by Channel 0, Phase1 denotes a phase of the first reflected EM signal corresponding to the object when received by Channel 1, and d denotes a distance between Channel 0 and Channel 1.

In the example shown in FIG. 5B, the first receiving antenna array of the radar 104-2 includes more than two channels, e.g., Channel 0, Channel 1, . . . , Channel N−1, where N is a positive integer greater than 2. In some embodiments, the first object direction angle of the object 306 can be calculated by maximizing

$$y ( θ ) = x 0 + x 1 \cdot exp ( - j \cdot 2 π \frac{d sin θ}{λ} ) + … + x ( N - 1 ) \cdot exp ( - j \cdot 2 π \frac{( N - 1 ) d sin θ}{λ} ) \qquad ( 4 )$$

given that θ∈[−θmax1, θmax1], where x0, x1, . . . , and x(N−1) respectively denote a phase of the first reflected EM signal corresponding to the object when received by Channel 0, Channel 1, . . . , and Channel (N−1), respectively. In this example, it is assumed that the channels are arranged at an equal interval d.

In some embodiments, the first receiving antenna array includes more than two channels but not all of the channels are used to calculate the first object direction angle of the object 306. In some embodiments, only two of the more than two channels are used in the calculation, and equation (3) can be used.

According to the disclosure, the second measurement can be performed in a manner similar to that described above for the first measurement, except that all direction-specific parameters in the first measurement can be replaced with the direction-specific parameters in the second measurement. Within one “ping-pong” measurement, the first and second measurements can be performed in any order, i.e., the first measurement can be performed before or after the second measurement, or the first and second measurement can be performed approximately simultaneously.

In some embodiments, a non-direction-specific parameter, such as the candidate range, the candidate relative velocity, or the candidate signal strength, can be calculated in both the first and second measurements, and an average of the calculation results from the two measurements can be used as the final value of the parameter. Further, as discussed above, the period of time for the movable platform 100 to perform the first and second measurements is usually relative short, such as several milliseconds. Therefore, in some embodiments, either one of the calculation results from the two measurements can be used as the final value of the parameter.

Consistent with the disclosure, the object information obtained from one “ping-pong” measurement, including one first measurement and one second measurement, forms one “ping-pong”measurement frame, also referred to as a “measurement frame.” Each measurement frame contains the object information of one or more objects. By performing a plurality of “ping-pong” measurements, the radar data processing unit 104-4 can obtain a plurality of measurement frames. In some embodiments, to track and predict the one or more objects, the object information of each object in two measurement frames, such as two adjacent measurement frames, can be matched and correlated to establish a corresponding relationship of each object between the two measurement frames. When the measurement frames contain object information of multiple objects, the multiple objects can be numbered according to the corresponding relationships.

For example, assume n1 objects are detected in a current measurement frame and assume n2 objects are detected in a previous measurement frame, denoted by T_{q}, q∈[1, n2], then matching and correlating the object information of the objects in the two measurement frames includes calculating matching probabilities, also referred to as “threshold-association probabilities,” of the objects in the current measurement frame being the objects in the previous measurement frame. In some embodiments, for an object T_{q} in the previous measurement frame, a threshold area, also referred to as a “gate,” can be determined according to a range threshold between the movable platform 100 and the object T_{q}, a relative velocity threshold between the movable platform 100 and the object T_{q}, direction angle zone thresholds (including a first direction angle zone threshold and a second direction angle zone threshold) between the movable platform 100 and the object T_{q}, and statistic data of the n2 objects. In some embodiments, the threshold area can be determined based on a detection probability (described later) according to the range threshold, the relative velocity threshold, and the direction angle zone thresholds and may vary slightly according to results from test experiments. The statistic data can include, for example, an average value, a standard deviation, and/or a Mahalanobis distance of each of the object ranges, the object relative velocities, the first object direction angles, and the second object direction angles of n2 objects. In some embodiments, the gate can be centered at the object T_{q} and the threshold area, i.e., the gate, can be an area surrounding the object T_{q}.

After the threshold area, i.e., the gate, is determined, the number, L, of objects in the current measurement frame that falls in the gate is then determined. L=0 means no object in the current measurement frame matches the object T_{q} in the previous measurement frame, i.e., the matching probabilities for T_{q} are 0. L=1 means one object in the current measurement frame falls in the gate and that one object can be considered as perfectly matching the object T_{q}, i.e., the matching probability of T_{q} in the previous measurement frame and that one object in the current measurement frame is 100%. This means that the object T_{q} and that one object are the same object, which is also referred to as a “matched object.” Further, if L>1, then multiple objects, denoted by Mₚ, p∈[1, L], in the current measurement frame may possibly match the object T_{q} in the previous measurement frame, and thus the probability of each of these multiple objects in the current measurement frame matches the object T_{q} in the previous measurement frame can be calculated to determine which one of these multiple objects most likely matches the object T_{q}. In some embodiments, it is assumed that the distribution of the objects in the current measurement frame satisfies the Gaussian distribution. The probability of an object Mₚ that falls in the gate matches the object T_{q}, i.e., P(T_{q}|Mₚ), can be calculated using the following equation:

$$P ( {T}_{q} \vert {M}_{p} ) = \frac{exp ( - \frac{1}{2} {VS}^{- 1} V )}{\frac{γ \sqrt{\vert 2 π S \vert} ( 1 - {P}_{D} {P}_{G} )}{{P}_{D}} + {\sum }_{p = 1}^{L} exp ( - \frac{1}{2} {VS}^{- 1} V )} \qquad ( 5 )$$

where γ denotes the density of the background clutters, V denotes the volume of the gate, S denotes the variance of the L objects in the current measurement frame that fall in the gate, which can be, for example, a sum of a range variance, a velocity variance, and an angle variance of the L objects, P_{D} denotes the detection probability, and P_{G} denotes the probability of the object Mₚ in the current measurement frame correctly falls in the gate. The detection probability P_{D} can usually be set as 1 (one) assuming target(s) in the gate will be tracked. In some embodiments, the detection probability P_{D} can be set to have a value near to but smaller than 1 (one) because sometimes the target(s) cannot be tracked for reasons such as device breakdown. After the matching probabilities are calculated, the object Mₚ that has the highest matching probability can be determined as the object in the current measurement frame that matches the object T_{q} in the previous measurement frame, i.e., they are the same object (matched object). In some embodiments, the object information of the matched object can be smoothed, e.g., using a filter, to further reduce the noise and improve the signal-to-noise ratio. When multiple objects are matched, the matched objects can be numbered.

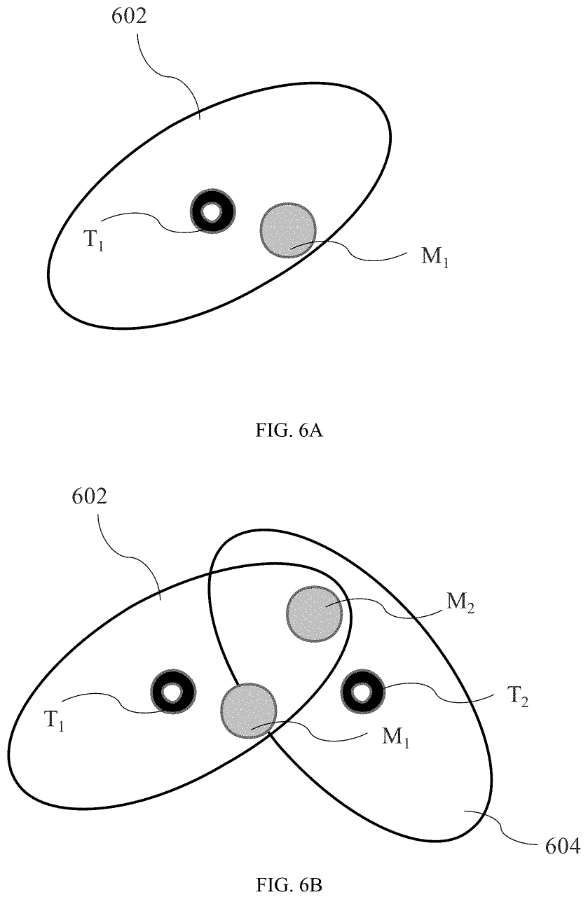

FIGS. 6A and 6B illustrates exemplary matching of object(s) in a previous measurement frame and a current measurement frame consistent with the disclosure. FIG. 6A shows the scenario with one object and FIG. 6B shows the scenario with two objects. As shown in FIG. 6A, an object T₁ in the previous measurement frame is identified, and a gate 602 is determined for the object T₁. Further, an object M₁ is identified in the current measurement frame. Since the object M₁ falls in the gate 602, it can be determined that the object M₁ in the current measurement frame matches with the object T₁ in the previous measurement frame. In FIG. 6B, objects T₁ and T₂ in the previous measurement frame are identified. Gates 602 and 604 are determined for the objects T₁ and T₂, respectively. Further, objects M₁ and M₂ in the current measurement frame are identified. M₁ falls in the gate 602 and is at the boundary of the gate 604. M₂ falls in both of the gates 602 and 604. The results obtained from the calculation discussed above indicate that the object M₁ has a higher matching probability with the object T₁ than M₂, and that the object M₂ has a higher matching probability with the object T₂ than M₁. Therefore, the object T₁ in the previous measurement frame may be matched with the object M₁ in the current measurement frame, and the object T₂ in the previous measurement frame may be matched with the object M₂ in the current measurement frame. As show in FIG. 6B, M₁ is closer to T₁ while M₂ is closer to T₂.

In some embodiments, the radar data processing unit 104-4 can obtain movement control information such as, for example, coordinates (latitude, longitude, and elevation) of the movable platform 100 in the geographic coordinate system, a velocity of the movable platform 100, and/or acceleration information of the movable platform 100. In some embodiments, the movable platform 100 is an aircraft, such as an UAV, and the movement control information can further include an attitude of the movable platform 100. In some embodiments, the radar data processing unit 104-4 can obtain the acceleration from the IMU 206 and other movement control information from the movement control unit 208. In some embodiments, the radar data processing unit 104-4 can obtain the movement control information from the movement control unit 208. Based on the object information of the matched object and the movement control information, the radar data processing unit 104-4 can track the matched object and predict future object information of the matched object.

Specifically, based on the predicted object information, the radar data processing unit 104-4 can determine a real-time motion model of the movable platform 100, which may include at least one of a uniform motion model corresponding to a zero acceleration, a uniformly accelerated motion model corresponding to a uniform acceleration, or a nonuniformly accelerated motion model corresponding to a nonuniform acceleration. The different motion models can be pre-built and the radar data processing unit 104-4 can choose one or more appropriate models for the purpose of tracking the matched object. Then, based on the real-time motion model of the movable platform 100, the radar data processing unit 104-4 can apply a predetermined filtering algorithm to the object information of the matched object, to predict future object information of the matched object. The predetermined filtering algorithm may include but is not limited to the Kalman filtering algorithm or the particle filtering algorithm.

Kalman filtering algorithm has been widely adopted to track and estimate state of a system and the variance or uncertainty of the estimate. The estimate is updated using a state transition model and measurements. In some embodiments, the state transition model may be determined in real time according to the real-time motion model of the movable platform 100. Thus, the predication accuracy of the future object information of the matched object may be improved.

Based on the predicted future object information of the matched object, the movement control unit 208 can calculate a movement plan for the movable platform 100 to avoid the matched object. In some embodiments, based on the predicted future object information of the matched object, the radar data processing unit 104-4 can obtain position information and relative velocity information of the matched object in a spherical coordinate system, in which the movable platform 100 is the origin. The position information and the relative velocity information of the matched object in the spherical coordinate system can be expressed as (r, θ, φ) and (vᵣ, v_{θ}, vₚ), respectively, where r denotes the radial distance, θ denotes the polar angle, and φ denotes the azimuth angle.

The radar data processing unit 104-4 then converts the position information and relative velocity information of the matched object from the spherical coordinate system to a Cartesian coordinate system, in which the movable platform 100 is the origin, based on a conversion relationship between the spherical coordinate system and the Cartesian coordinate system. The position information and the relative velocity information of the matched object in the Cartesian coordinate system may be expressed as (x, y, z) and (vₓ, v_{y}, v_{z}), respectively, where vₓ denotes the component of the relative velocity in the x-direction, v_{y} denotes the component of the relative velocity in the y-direction, and v_{z} denotes the component of the relative velocity in the z-direction.

The position information and relative velocity information of an object in the Cartesian coordinate system are also collectively referred to as three-dimensional (3D) depth information of the object. Based on the predicted future object information of the matched object, the 3D depth information of the matched object in front of the movable platform 100 can be obtained in real time. Given that the motion mode of the movable platform 100 remains the same, the radar data processing unit 104-4 can calculate a time when the movable platform 100 and the matched object will collide, based on the position information and relative velocity information of the matched object in the Cartesian coordinate system.

Based on the time when the movable platform 100 and the matched object will collide, the position information and relative velocity information of the matched object in the Cartesian coordinate system, and the movement control information, the movement control unit 208 can calculate the movement plan to avoid the matched object, and operate the movable platform 100 according to the movement plan.

In some embodiments, the movement plan can include adding a superimposition velocity onto a current velocity of the movable platform 100, i.e., superimposing a maneuvering velocity onto the current velocity of the movable platform 100.

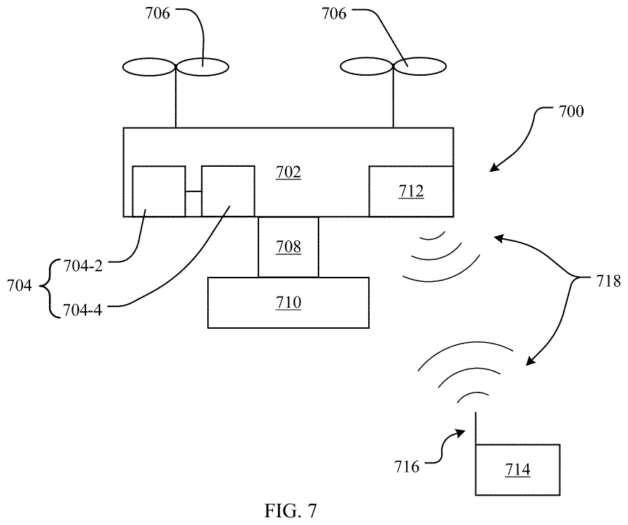

As discussed above, a movable platform consistent with the disclosure can include an UAV. FIG. 7 schematically illustrates an exemplary UAV 700 consistent with the disclosure. The UAV 700 can be any suitable type of UAV, such as an aerial rotorcraft that is propelled by multiple rotors. As shown in FIG. 7, the UAV 700 includes a fuselage 702, i.e., the body of the UAV 700, a radar-based object avoidance system 704 installed on the fuselage 702, and a plurality of rotors 706 connected to the fuselage 702.

The fuselage 702 constitutes a housing for accommodating various components of the UAV 700, such as, for example, a control system (which may include the radar-based object avoidance system 704), one or more inertial measuring units (IMUs), one or more processors, one or more power sources, and/or other sensors. The rotors 706 can be connected to the fuselage 702 via one or more arms or extensions that can branch from edges or a central portion of the fuselage 702, and can be mounted at or near the ends of the arms. The rotors 706 are configured to generate lift for the UAV 700, and serve as propulsion units that can enable the UAV 700 to move about freely in the air.

The radar-based object avoidance system 704 is similar to the radar-based object avoidance system 104 shown in FIGS. 1 and 2, and includes a radar 704-2 and a radar data processing unit 704-4. The radar 104-2 can be directly mounted on the fuselage 702 of the UAV 700. For example, the radar 704-2 can be mounted on the front, the back, the left, or the right of the fuselage 702 of the UAV 700. Further, the radar 704-2 can be mounted on any appropriate portion of the fuselage 702 through any appropriate mechanism, as long as such a mounting allows the radar 704-2 to efficiently transmit EM signals and receive reflected EM signals from the object(s). The radar 704-2 is similar to the radar 104-2, and thus detailed description thereof is omitted. In some embodiments, the radar 704-2 may be especially adapted for use in the UAV 700. For example, the radar 704-2 may be power efficient, lightweight, and compact to avoid over-encumbering the UAV 700. The radar-based object avoidance system 704 can be configured to perform a method consistent with the disclosure, such as one similar to the exemplary methods described in the disclosure, to detect the object(s) near the UAV 700 and to predict future object information of the object(s) for calculating a flight plan that allows the UAV 700 to avoid the object(s).

In some embodiments, as shown in FIG. 7, the UAV 700 further includes a gimbal mechanism 708 disposed on the fuselage 702, such as, for example, below the fuselage 702. The gimbal mechanism 708 is configured to hold an imaging device 710, such as a camera, which can be part of the UAV 700 or a device independent of the UAV 700. In some embodiments, the radar 704-2 can also be attached to the gimbal mechanism 708, and thus can have a rotational freedom about one or more axes with respect to the fuselage 702.

In some embodiments, as shown in FIG. 7, the UAV further includes a wireless communication interface 712 for communicating with a remote control 714 having an antenna 716. The wireless communication interface 712 can be an electronic circuit configured to generate, transmit, and receive wireless signals 718. The remote control 714 receives and transmits the wireless signals 718 via the antenna 716, and can control the operation of the UAV 700. For example, the remote control 714 can send acceleration signals or flight control signals to the UAV 700. The acceleration signals can instruct the UAV 700 to, for example, accelerate, decelerate, or keep constant velocity. The acceleration signals can also instruct the UAV 700 to accelerate or decelerate at a constant or a varying acceleration. The flight control signals can include, for example, various status control information, such as taking off, landing, or turning. The UAV 700 can further include other appropriate components not shown in FIG. 7.

The UAV 700 shown in FIG. 7 is for illustrative purposes and is not intended to limit the scope of the disclosure. For example, the UAV 700 may have four rotors 706 and is known as a quadcopter, quadrotor helicopter, or quad rotor. Other UAV designs suitable for the systems and methods consistent with the disclosure may include, but not limited to, single rotor, dual rotor, trirotor, hexarotor, and octorotor designs. Fixed wing UAVs and hybrid rotorcraft-fixed wing UAVs may also be used.

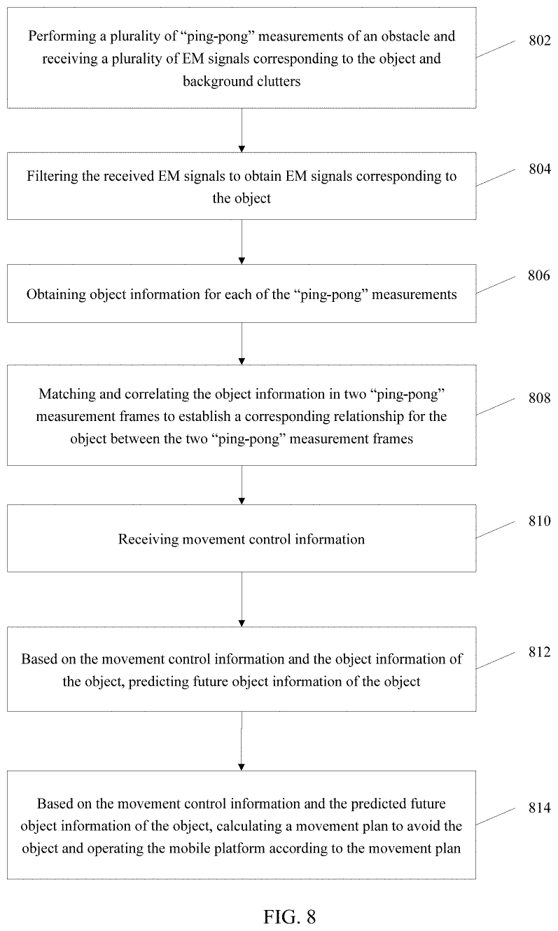

The present disclosure also provides a method for radar-based object avoidance for a movable platform. FIG. 8 illustrates a flow chart of an exemplary method for radar-based object avoidance for a movable platform consistent with the disclosure.

As shown in FIG. 8, at 802, a plurality of “ping-pong” measurements of an object are performed, and EM signals corresponding to the object and background clutters are received. As discussed above, one “ping-pong” measurement may include a first measurement in a first direction (such as a horizontal measurement in a horizontal direction) and a second measurement in a second direction (such as a vertical measurement in a vertical direction).

At 804, the received EM signals are filtered to obtain EM signals corresponding to the object. In some embodiments, the received EM signals can be filtered according to at least one of range information calculated based on the EM signals, relative velocity information calculated based on the EM signals, or a CFAR detection algorithm.

At 806, object information of the object is obtained for each of the “ping-pong” measurements. In some embodiments, the object information may include an object range, an object relative velocity, and object direction angles, which forms one “ping-pong” measurement frame, as discussed above.

At 808, the object information in two “ping-pong” measurement frames are matched and correlated to establish a corresponding relationship for the object between the two “ping-pong” measurement frames. In the embodiments where multiple objects are identified in each of the two “ping-pong” measurement frame, the objects are numbered.

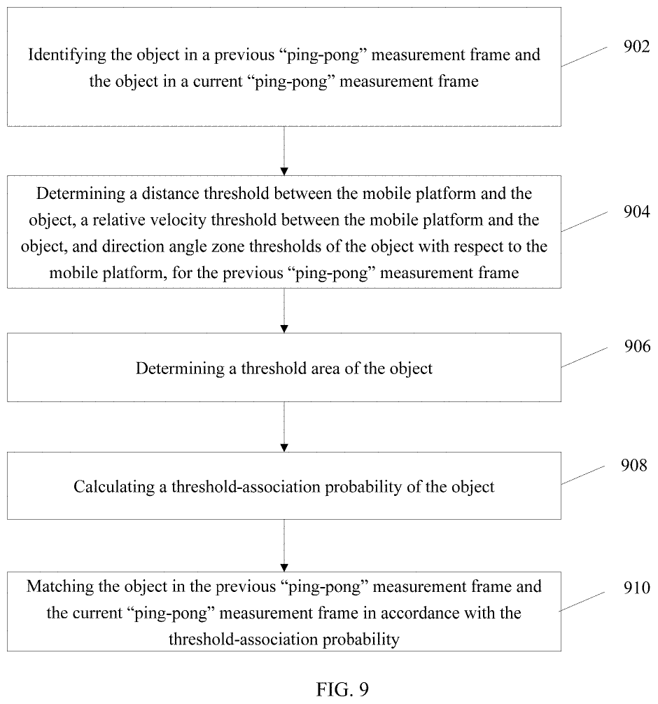

FIG. 9 illustrates a flow chart of an exemplary method for matching and correlating object information in the two “ping-pong” measurement frames to establish a corresponding relationship of the object in the two “ping-pong” measurement frames. As shown in FIG. 9, at 902, the object in a previous “ping-pong” measurement frame and the object in a current “ping-pong” measurement frame are identified.

At 904, a distance threshold between the movable platform and the object, a relative velocity threshold between the platform and the object, and direction angle zone thresholds of the object with respect to the movable platform are determined for the previous “ping-pong” measurement frame.

At 906, based on the distance threshold, the relative velocity threshold, the direction angle zone thresholds, and statistic data of the object, a threshold area of the object is determined.

At 908, a matching probability of the object is calculated.

At 910, the object in the previous “ping-pong” measurement frame and the object in the current “ping-pong” measurement frame are matched according to the matching probability. That is, the object in the previous “ping-pong” measurement frame and the object in the current “ping-pong” measurement frame are the same object, which is also referred to as a “matched object.”

Referring again to FIG. 8, at 810, movement control information is received.

At 812, future object information of the matched object is predicted based on the movement control information and the object information of the matched object.

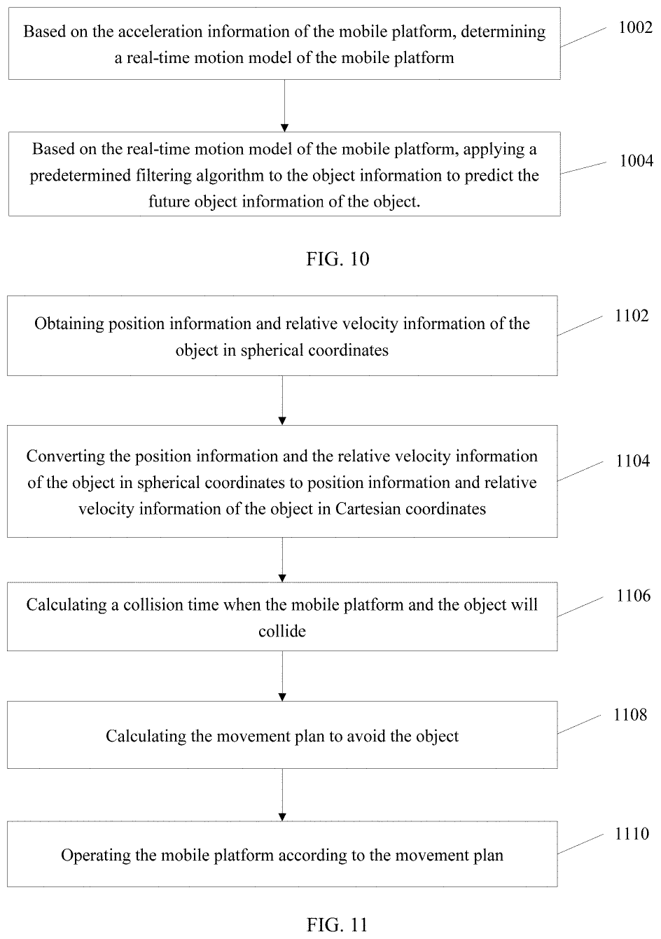

FIG. 10 illustrates a flow chart of an exemplary method for predicting the future object information of the matched object consistent with the disclosure. As shown in FIG. 10, at 1002, a real-time motion model of the movable platform is determined based on acceleration information of the movable platform. The acceleration information can be generated by the IMU on the movable platform. At 1004, based on the real-time motion model of the movable platform, a predetermined filtering algorithm is applied to the object information of the matched object to predict the future object information of the matched object.

Referring again to FIG. 8, at 814, a movement plan for avoiding the matched object is calculated based on the predicted object information of the matched object and the movement control information.

FIG. 11 illustrates a flow chart of an exemplary method for calculating a movement plan and operating the movable platform according to the movement plan consistent with the disclosure. As shown in FIG. 11, at 1102, position information and relative velocity information of the matched object in spherical coordinates are obtained based on the predicted obstacle information of the numbered obstacles. At 1104, the position information and the relative velocity information of the matched object in spherical coordinates are converted to position information and relative velocity information of the matched object in Cartesian coordinates based on a conversion relationship between the spherical coordinate system and the Cartesian coordinate system. At 1106, a collision time when the movable platform and the matched object may collide if the motion mode of the movable platform remains unchanged is calculated based on the position information and relative velocity information of the matched object in Cartesian coordinates. At 1108, the movement plan to avoid the matched object is calculated based on the collision time, the position information and the relative velocity information of the matched object in Cartesian coordinates, and the movement control information. At 1110, the movable platform is operated according to the movement plan.

The description of the disclosed embodiments is provided to illustrate, rather than limiting, the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for radar-based object avoidance for a movable platform, comprising:
performing a plurality of “ping-pong” measurements to receive electromagnetic (EM) signals corresponding to an object and background clutters by a radar of the movable platform; and
distinguishing the object from the background clutters,
wherein each of the “ping-pong” measurements includes a first measurement and a second measurement, and a first direction of the first measurement is different from a second direction of the second measurement.

2. The method according to claim 1, wherein:
the first measurement and the second measurement include a horizontal measurement and a vertical measurement, respectively.

3. The method according to claim 1, wherein distinguishing the object from the background clutters includes:
calculating range information and relative velocity information from the received EM signals; and
distinguishing the object from the background clutters according to at least one of the range information, the relative velocity information, or strength levels of the received EM signals.

4. The method according to claim 3, wherein:
distinguishing the object from the background clutters according to the strength levels of the received EM signals includes applying a constant-false-alarm-rate detection algorithm to the received EM signals.

5. The method according to claim 3,
wherein the radar includes at least two first channels arranged in the first direction and at least two second channels arranged in the second direction,
the method further comprising:
determining a first direction angle of the object with respect to the movable platform in the first direction according to first phase information of EM signals corresponding to the object received by the at least two first channels, a distance between the at least two first channels, and a wavelength of EM signals transmitted by the radar; and
determining a second direction angle of the object with respect to the movable platform in the second direction according to second phase information of the EM signals corresponding to the object received by the at least two second channels, a distance between the at least two second channels, and the wavelength.

6. The method according to claim 5, further comprising:
matching and correlating object information of the object between two “ping-pong” measurement frames;
establishing a corresponding relationship for the object between the two “ping-pong” measurement frames;
predicting future object information of the object; and
calculating a movement plan to avoid the object according to the future object information,
wherein the object information of the object includes an object range from the movable platform to the object, an object relative velocity between the movable platform and the object, and object direction angles of the object with respect to the movable platform.

7. The method according to claim 6, wherein:
in a same “ping-pong” measurement frame, the object information remains substantially the same.

8. The method according to claim 6, wherein matching and correlating the object information and establishing the corresponding relationship include:
identifying the object in a previous “ping-pong” measurement frame and the object in a current “ping-pong” measurement frame;
determining a distance threshold between the movable platform and the object, a relative velocity threshold between the movable platform and the object, and direction angle zone thresholds of the object with respect to the movable platform, for the previous “ping-pong” measurement frame;
determining, based on the distance threshold, the relative velocity threshold, the direction angle zone thresholds, and statistic data of the object, a threshold area of the object;
calculating a matching probability of the object between the previous “ping-pong” measurement frame and the current “ping-pong” measurement frame; and
matching the object in the previous “ping-pong” measurement frame and the current “ping-pong” measurement frame in accordance with the matching probability.

9. The method according to claim 6, wherein predicting the future object information includes:
receiving acceleration information of the movable platform from an inertial measuring unit on the movable platform;
determining, based on the received acceleration information, a real-time motion model of the movable platform, wherein the real-time motion model includes at least one of a uniform motion model corresponding to zero acceleration, a uniformly accelerated motion model corresponding to uniform acceleration, or a nonuniformly accelerated motion model corresponding to nonuniform acceleration; and
applying, based on the real-time motion model, a predetermined filtering algorithm to the EM signals corresponding to the object to predict the future object information, wherein the predetermined filtering algorithm includes at least one of a Kalman filtering algorithm or a particle filtering algorithm.

10. The method according to claim 6, wherein calculating the movement plan includes:
obtaining, based on the predicted future object information of the object, the object range and the object relative velocity of the object in spherical coordinates;
converting the object range and the object relative velocity of the object in spherical coordinates to the object range and the object relative velocity of the object in Cartesian coordinates;
calculating a collision time when the movable platform and the object will collide if a motion mode of the movable platform remains the same; and
calculating, based on the collision time, and the object range and the object relative velocity of the object in Cartesian coordinates, the movement plan.

11. A system for radar-based object avoidance for movable platform comprising:
a radar, configured to perform a plurality of “ping-pong” measurements of to receive electromagnetic (EM) signals corresponding to an object and background clutters; and
a radar data processing unit, configured to distinguish the object from the background clutters,
wherein each of the “ping-pong” measurements includes a first measurement and a second measurement, and a first direction of the first measurement is different from a second direction of the second measurement.

12. The system according to claim 11, wherein:
the first measurement and the second measurement include a horizontal measurement and a vertical measurement, respectively.

13. The system according to claim 11, wherein the radar data processing unit is further configured to:
calculate range information and relative velocity information from the received EM signals; and
distinguish the object from the background clutters according to at least one of the range information, the relative velocity information, and strength levels of the received EM signals.

14. The system according to claim 13, wherein the radar data processing unit is further configured to:
apply a constant-false-alarm-rate detection algorithm to the received EM signals to distinguish the object from the background clutters according to the strength levels of the received EM signals.

15. The system according to claim 13, wherein:
the radar includes at least two first channels arranged in the first direction and at least two second channels arranged in the second direction, and
the radar is further configured to:
calculate a first direction angle of the object with respect to the movable platform in the first direction according to first phase information of EM signals corresponding to the object received by the at least two first channels, a distance between the at least two first channels, and a wavelength of EM signals transmitted by the radar; and
calculate a second direction angle of the object with respect to the movable platform in the second direction according to second phase information of the EM signals corresponding to the object received by the at least two second channels, a distance between the at least two second channels, and the wavelength.

16. The system according to claim 15, wherein the radar data processing unit is further configured to:
match and correlate object information of the object between two “ping-pong” measurement frames;
establish a corresponding relationship for the object between the two “ping-pong” measurement frames;
predict future object information of the object; and
calculate a movement plan to avoid the object according to the future object information,
wherein the object information of the object includes an object range from the movable platform to the object, a relative velocity between the movable platform and the object, and object direction angles of the object with respect to the movable platform.

17. The system according to claim 16, wherein:
in a same “ping-pong” measurement frame of the objects, the object information remains substantially the same.

18. The system according to claim 16, wherein the radar data processing unit is further configured to:
identify the object in a previous “ping-pong” measurement frame and the object in a current “ping-pong” measurement frame;
determine a distance threshold between the movable platform and the object, a relative velocity threshold between the movable platform and the object, and direction angle zone thresholds of the object with respect to the movable platform, for the previous “ping-pong” measurement frame;
determine, based on the distance threshold, the relative velocity threshold, the direction angle zone thresholds, and statistic data of the objects, a threshold area of the object;
calculate a matching probability of the object between the previous “ping-pong” measurement frame and the current “ping-pong” measurement frame; and
match the object in the previous “ping-pong” measurement frame and the current “ping-pong” measurement frame in accordance with the threshold-association probability.

19. The system according to claim 16, wherein the radar data processing unit is further configured to:
receive acceleration information of the movable platform from an inertial measurement unit on the movable platform;
determine, based on the received acceleration information, a real-time motion model of the movable platform, wherein the real-time motion model includes at least one of a uniform motion model corresponding to zero acceleration, a uniformly accelerated motion model corresponding to uniform acceleration, and a nonuniformly accelerated motion model corresponding to nonuniform acceleration; and
apply, based on the real-time motion model, a predetermined filtering algorithm to the EM signals corresponding to the object to predict the future object information, wherein the predetermined filtering algorithm includes at least one of a Kalman filtering algorithm or a particle filtering algorithm.

20. The system according to claim 16, wherein the radar data processing unit is further configured to:
obtain, based on the predicted future object information of the object, the object range and the object relative velocity of the object in spherical coordinates;
convert the object range and the object relative velocity of the object in spherical coordinates to the object range and the object relative velocity of the object in Cartesian coordinates;
calculate a collision time when the movable platform and the numbered objects will collide; and
calculate, based on the collision time, and the object range and the object relative velocity of the object in Cartesian coordinates, the movement plan.
